(19) United States
(12) Patent Application Publication
(10) Pub. No.: US 2016/0157189 A1
(43) Pub. Date: Jun. 2, 2016

(54) Method for Determining Multiple Transmit Powers in a Cellular Wireless Communication System

(71) Applicant: Huawei Technologies Co., Ltd., Shenzhen (CN)

(72) Inventor: Hong Li, Shanghai (CN)

(21) Appl. No.: 15/006,552

(22) Filed: Jan. 26, 2016

Related U.S. Application Data
(63) Continuation of application No. PCT/EP2013/065832, filed on Jul. 26, 2013.

(51) Int. Cl. H04W 52/34; H04W 52/46

(52) U.S. Cl. CPC H04W 52/346; H04W 52/46

(57) ABSTRACT

A method is provided for determining multiple transmit powers in a cellular wireless communication system which comprises a network control node, M number of neighbouring relay nodes j=1,2, . . . , M, and N number of user nodes i =1,2, . . . , N; the N user nodes being served by the M relay nodes, and the network control node cooperating with the M relay nodes by acting as a donor network control node for the M relay nodes. The method comprises the step of: simultaneously calculating transmit powers for each user node and each relay node by maximising a utility function f(pᵢ^{u}, pⱼ^{r}) expressing a ratio of a sum of channel capacities for the N user nodes over a sum of transmit powers for the N user nodes and the M relay nodes, where pᵢ^{u} is the transmission power for user node i and pⱼ^{r} is the transmission power for relay node j.

This application is a continuation of International Application No. PCT/EP2013/065832, filed on Jul. 26, 2013, which is hereby incorporated by reference in its entirety.

### TECHNICAL FIELD

The present invention relates to a method for determining multiple transmit powers in a cellular wireless communication system. Furthermore, the invention also relates to a communication device, a computer program, and a computer program product thereof.

### BACKGROUND

Long Term Evolution (LTE) is a well known communication standard for cellular wireless communication of high-speed data for mobile phones and data terminals. It is based on the GSM/EDGE and UMTS/HSPA network technologies, and increases the capacity and speed by using a different radio interface together with core network improvements.

The LTE standard is developed by the 3GPP (3rd Generation Partnership Project) and is specified in its Release 8 document series, with minor enhancements described in Release 9. LTE Advanced-LTE Release 10 is set to provide higher bitrates in a cost efficient way and, at the same time, completely fulfil the requirements set by ITU for IMT Advanced, also referred to as 4G.

The high-level network architecture of LTE is comprised of following three main components as shown in FIG. 1. User Equipment (UE), Evolved UMTS Terrestrial Radio Access Network (E-UTRAN), Evolved Packet Core (EPC) where EPC is the core network; The Home Subscriber Server (HSS) component has been carried forward from UMTS and GSM and is a central database that contains information about all the network operator's subscribers. The Packet Data Network (PDN) Gateway (P-GW) communicates with the outside world, i.e. packet data networks PDN, using SGi interface. Each packet data network is identified by an Access Point Name (APN). The PDN gateway has the same role as the GPRS support node (GGSN) and the serving GPRS Support Node (SGSN) with UMTS and GSM. The serving gateway (S-GW) acts as a router, and forwards data between the base station and the PDN gateway. The Mobility Management Entity (MME) controls the high-level operation of the mobile by means of signalling messages and Home Subscriber Server (HSS). The Policy Control and Charging Rules Function (PCRF) is a component, which is not shown in FIG. 1, which is responsible for policy control decision-making, as well as for controlling the flow-based charging functionalities in the Policy Control Enforcement Function (PCEF), which resides in the P-GW.

Each eNB (i.e. a base station) connects with the EPC by means of the so called S1 interface and the eNB can also be connected to nearby base stations by the X2 interface, which is mainly used for signalling and packet forwarding during handover. The interface between the serving and PDN gateways is known as the S5/S8. This has two slightly different implementations, namely S5 if the two devices are in the same network, and S8 if they are in different networks.

Furthermore, relaying have also been considered for LTE-Advanced networks as a tool to e.g. improve coverage of high data rates, group mobility, temporary network deployment, cell-edge throughput and/or to provide coverage in new areas.

The Relay Node (RN) in this type of systems is wireles sly connected to the radio-access network via a so called donor cell associated with a network control node such as a base station. The architecture for supporting relay nodes is shown in FIG. 2. The relay node terminates the S1, X2 and Un interfaces. Relay technology is mainly used to increase cell coverage and user throughput at cell edges in the sense that the RN can improve the quality of the channel between a cell-edge user and the base station by replacing one poor channel with two good channels.

However, compared to the traditional wireless cellular network without relay nodes, the relay network consumes more energy in the sense that the relay node usually operates using much more power than UE. The gain of network capacity and coverage largely results from the extra energy consumption on relay nodes.

### SUMMARY

An objective is to provide a solution which mitigates or solves the drawbacks and problems of prior art solutions. Another objective is to provide a solution for energy efficient transmissions in cellular relay networks.

According to a first aspect, the above mentioned objectives are achieved by a method for determining multiple transmit powers in a cellular wireless communication system which comprises: at least one network control node, M number of neighboring relay nodes j=1,2, . . . , M, and N number of user nodes i=1,2, . . . , N; said N user nodes being served by said M relay nodes, and said network control node cooperating with said M relay nodes by acting as a donor network control node for said M relay nodes. The method comprises the step of simultaneously calculating transmit powers for each user node and each relay node by maximizing a utility function f(p_îu,p_ĵr) expressing a ratio of a sum of channel capacities for said N user nodes over a sum of transmit powers for said N user nodes and said M relay nodes, where p_î u is the transmission power for user node i and p_ĵr is the transmission power for relay node j.

Different embodiments of the above method are defined in the appended dependent claims.

Furthermore, the present method may be comprised in a computer program which when run by processing means causes the processing means to execute the present method. A computer program product may comprise the computer program and a computer readable medium.

According to a second aspect, the above mentioned objectives are achieved with a communication device arranged for communication in a cellular wireless communication system which comprises: at least one network control node, M number of neighboring relay nodes j=1,2, . . . , M, and N number of user nodes i=1,2, . . . , N; said N user nodes being served by said M relay nodes, and said network control node cooperating with said M relay nodes by acting as a donor network control node for said M relay nodes. The communication device comprises a calculating unit arranged for simultaneously calculating transmit powers for each user node and each relay node by maximizing a utility function f(p_îu,p_ĵr) expressing a ratio of a sum of channel capacities for said N user nodes over a sum of transmit powers for said N user nodes and said M relay nodes, where p_îu is the transmission power for user node i and p_ĵr is the transmission power for relay node j.

The communication device may be modified, mutatis mutandis, according to the different embodiments.

Embodiments provide an algorithm for calculating the transmit powers for user nodes and relay nodes in a cellular relay network which considers the energy efficiency in mentioned networks, i.e. the channel capacities over transmit powers, using a novel utility function. Hence, by maximizing the utility function which expresses the energy efficiency for obtaining the transmit powers, a transmit power efficient algorithm is provided. Thereby, the energy efficiency of the relay network is improved without loss of capacity.

Furthermore, a cooperative relay scheme for user nodes and its associated relay nodes and the donor network control node is also provided which provides further advantages over prior art.

Further applications and advantages of the invention will be apparent from the following detailed description.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an overview of the LTE system architecture;

FIG. 2 shows an overview of the E-UTRAN architecture supporting Relay Nodes (RNs);

FIG. 3 shows the layout of the classic cellular network (the left figure) and a relay network I (the right figure);

FIG. 4 shows the layout of the classic cellular network (the left figure) and relay network II (the right figure);

FIG. 5 illustrates different radio channels and the transmission/reception flow of a cooperative relay scheme according to an embodiment; and

FIG. 6 is a flowchart illustrating an embodiment of a cooperative scheme.

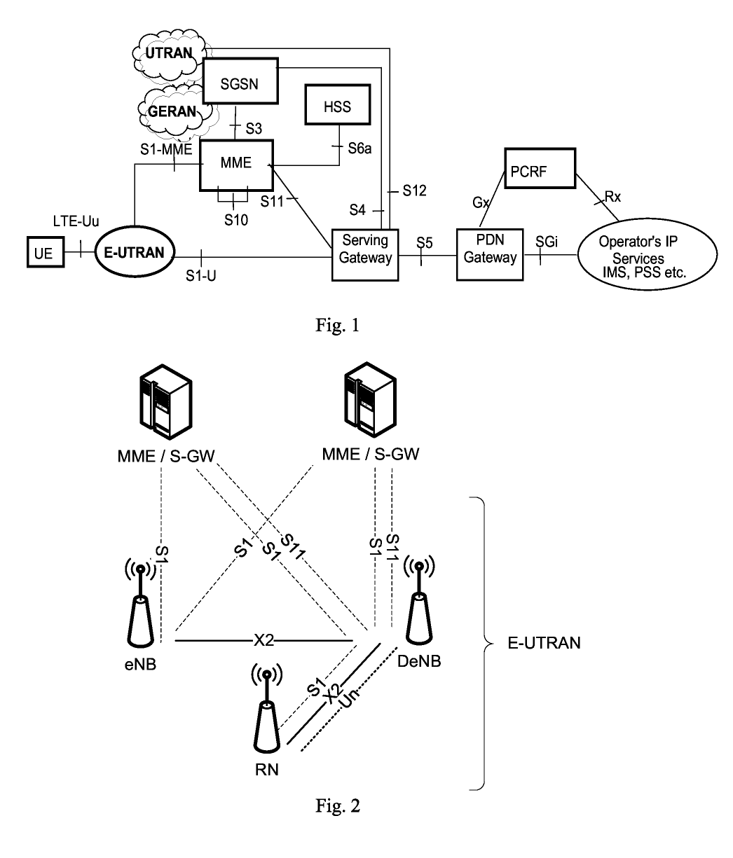

### DETAILED DESCRIPTION OF ILLUSTRATIVE EMBODIMENTS

The present invention considers and solves how to achieve a balance between energy consumption and capacity in cellular relay networks, i.e. the energy efficiency which is defined as the capacity divided by the total energy consumption thereof. Embodiments provide a novel solution which improves the energy efficiency of the relay network without loss of capacity by controlling the transmit power of mobile nodes and relay nodes. More precisely, the energy efficiency as herein defined has not to the knowledge of the inventor ever been considered.

The transmit powers of User Nodes (UNs) and Relay Nodes (RNs), respectively, are determined by solving a specific utility function according to the present invention. Generally, embodiments comprise the step of: simultaneously calculating transmit powers for each UN (e.g. a mobile station such as a UE) and each RN by maximising a utility function f(pᵢ^{u}, pⱼ^{r}) expressing a ratio of a sum of channel capacities for said N UNs over a sum of transmit powers for said N UNs and said M RNs, where pᵢ^{u} is the transmission power for UN i and pⱼ^{r} is the transmission power for RN j. Correspondingly, the UNs and RNs transmit communication signals in the uplink with the respective calculated transmit powers.

The present utility function is constructed as maximizing the ratio of capacity and the total energy consumption with constraint that the channel capacity for each UN exceeds a given channel capacity threshold θ_{c} according to an embodiment. According to another embodiment the utility function has transmission power constraints for respective UNs and RNs, and hence the utility function can be expressed as:

$$max f ( {p}_{i}^{u} , {p}_{j}^{r} ) = \frac{{\sum }_{i = 1}^{N} {C}_{i}}{{\sum }_{i = 1}^{N} {p}_{i}^{u} + {\sum }_{j = 1}^{M} {p}_{j}^{r}}$$

s.t. Cᵢ≧θ_{c},

pₘᵢₙ^{u}≦pᵢ^{u}≦pₘₐₓ^{u},pₘᵢₙ^{r}≦pⱼ^{r}≦pₘₐₓ^{r}, i=1,2, . . . N, j=1,2, . . . M.

where θ_{c} is the threshold of minimal capacity, pₘᵢₙ^{u}, pₘᵢₙ^{r}, pₘₐₓ^{u}, pₘₐₓ^{r} are the pre-set threshold of minimal and maximal transmission power of UN and RN, respectively, where pᵢ^{u} is the power of signal transmission of UN i, pⱼ^{r} is the power of signal transmission of RN j, N is the number of UNs and M is the number of RNs and Cᵢ is the capacity of UN i.

The channel capacity threshold θ_{c} may be fixed (i.e. static) or vary over time depending on one or more other parameters. Mentioned parameters may according to an embodiment e.g. relate to distribution of UNs, or capacity threshold set by a Network Control Node (NCN) for direct communication between the UNs and the NCN.

The present method for calculation of the transmit powers may be performed in any suitable NCN of the cellular system. According to an embodiment the calculations are performed in the NCN and thereafter signalled to the UNs and RNs via suitable channels. Hence, the transmission powers of the UNs and RNs can be performed as power control in a fast or slow power control loop. A suitable network control node is the base station node used in some cellular systems. Hence, the cellular system may be a 3GPP communication system and the base station an eNB, and the UNs are UEs according to another embodiment.

According to yet another embodiment the RNs operate in Decode-and-Forward (DF) mode. In the DF mode, a relay node decodes and re-encodes the received signals from the user nodes which it serves before forwarding the received signals to the donor network control node for further processing.

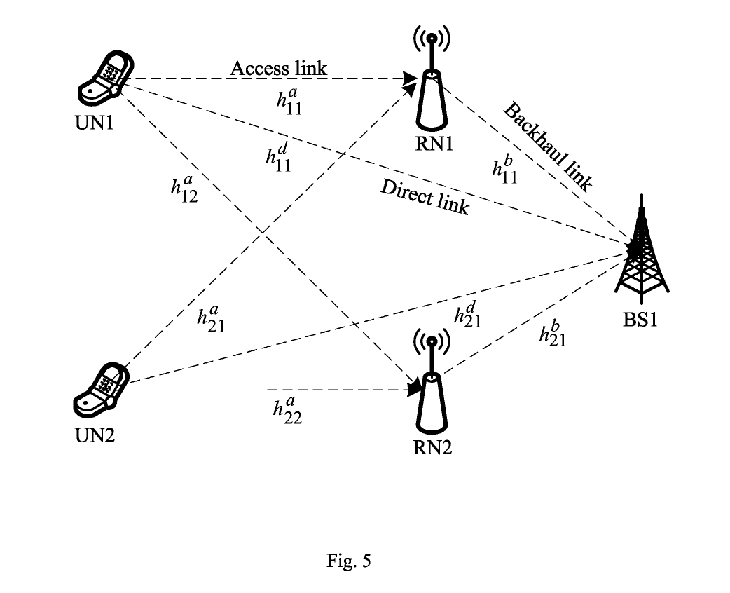

The present invention also provides a cooperative relay scheme according to an embodiment. With reference to FIG. 5; three links are involved in the present relay scheme, i.e.: the direct link, the access link and the backhaul link. The direct link is the link between the UNs and the NCN; the access link refers to the link between the UNs and the RNs; while the backhaul link is the link between the RNs and the donor NCN.

According to this embodiment, the cooperative relay scheme in this disclosure work on the uplink of the cellular system and further the RNs operate in the well-known Decode-and-Forward mode which has been explained above. Moreover, the cooperative relay scheme in this setting involves first (RN1) and second (RN2) neighbouring RNs, first (UN1) and second (UN2) UNs served by the first RN1 and second RN2 relay nodes, respectively, and a donor NCN. It should however be noted that this method easily can be extended to RNs operating in Amplify and Forward (AF) mode. The difference is that in the AF mode the RNs forward signals according to the Alamouti scheme in the physical layer on the backhaul link, and hence the calculation of capacity will be a bit different compared to the method described below.

The general cooperative method according to this embodiment includes:

UN1 and UN2 transmit at a first time slot t₁ communication signals s₁ and s₂, respectively;
RN1, RN2 and the NCN receives signals s₁ and s₂;
RN1 and RN2 forward s₁ and s₂ to the NCN at a second time slot t₂;
NCN receives the s₁ and s₂ from the RN1 and RN2;
The NCN calculates the channel capacities Cᵢ for UN1 and UN2, respectively, based on the signals received from the RNs and the UNs.

This embodiment may further be modified such that the forwarding from RN1 and RN2 to the NCN follows the Alamouti scheme which means that the method further comprises:
RN1 and RN2 forward/transmit at a third time slot t₃−s₂* and s₁* (where * denotes the complex conjugate), respectively, to the NCN,
The NCN receives the −s₂* and s₁* from RN1 and RN2, and
Combining by the NCN all received representation of the signals s₁ and s₂.

The NCN therefore combines all received representation of signals s₁ and s₂ and computes the channel capacities for UN1 and UN2 to be used in the above mentioned utility function. The transmit scheme of the signals is implemented in space and time as shown in Table I.

TABLE I
SIGNAL TRANSMIT SCHEME

| Time Slot | UN1 | UN2 | RN1 | RN2 | BS |
|---|---|---|---|---|---|
| t₁ | S: s₁ | S: s₂ | R: r₁^{a} | R: r₂^{a} | R: r^{d} |
| t₂ = t₁ + T | — | — | S: s₁ | S: s₂ | R: r₁^{b} |
| t₃ = t₁ + 2T | — | — | S: −s₂* | S: s₁* | R: r₂^{b} |

Legend: T: symbol duration, S: send signal, R: receive signal, r₁^{a}, r₂^{a}: signals received at access link, r^{d}: signal received at direct link, r₁^{b}, r₂^{b}: signals received at backhaul link.

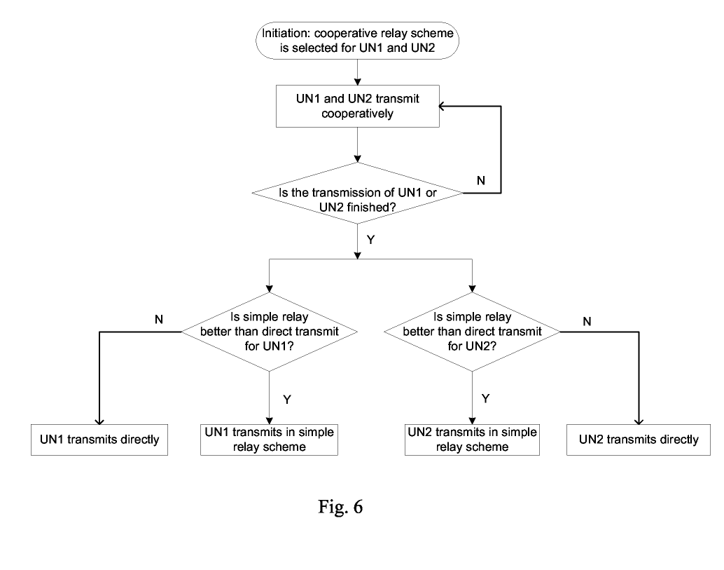

According to yet another embodiment, the cooperative relay scheme returns to a simple relay scheme or a direct transmit scheme if one of the UNs has no communication signals to transmit in the uplink. In the simple relay scheme the signals sent from the UN intended for the network control node are forwarded by the RN and in the direct transmit scheme the UNs transmit uplink signals directly to the NCN without intermediate relaying. FIG. 6 is a flow chart illustrating the above mentioned embodiment where N denotes No and Y denotes Yes.

As described above, the channel capacities for the UNs are computed by the NCN in the present cooperative relay scheme. For convenience in the following description, the channels between transmitters and receivers are as illustrated in FIG. 5. Further, it is assumed that all radio channels between the transmitters and receivers are modelled as quasi-static Rayleigh flat fading channels, and the fading is constant across two consecutive symbols, e.g. h₁₁^{a}(t₁)=h₁₁^{a}(t₁+T)=h₁₁^{a}(t₁+2T) for h₁₁^{a}, where T is the symbol duration. These assumptions are reasonable for the scenarios where UNs are fixed or moving slowly. Additive White Gaussian Noise (AWGN) is considered in the system model. Without loss of generality, BPSK modulation is assumed such that the original bit is bᵢ ∈ {0,1}, i=1,2, the modulated symbol will be sᵢ=BPSK(bᵢ) ∈ {+1, −1}.

1) Direct and Access Link Transmissions

UN1 and UN2 transmit s₁ and s₂, respectively, to RN1 and RN2 and NCN, the received signals are given by:

r₁^{a}=\sqrt{p₁^{u}}h₁₁^{a}s₁+\sqrt{p₂^{u}}h₂₁^{a}s₂+I₁^{a}+n₁^{a}

r₂^{a}=\sqrt{p₂^{u}}h₂₂^{a}s₂+\sqrt{p₁^{u}}h₁₂^{a}s₁+I₂^{a}+n₂^{a}

r^{d}=\sqrt{p₁^{u}}h₁₁^{d}s₁+\sqrt{p₂^{u}}h₂₁^{d}s₂+I^{d}+n^{d}

where p₁^{u}, p₂^{u} are the power of signal transmission of UN1 and UN2, n₁^{a}, n₂^{a}, n^{d} are thermal noise, I₁^{a}, I₂^{a} and I^{d} are the interference from other UNs in the whole network, the thermal noise and interference are assumed as Gaussian noise at the receivers in this disclosure.

The received signals \tilde{s}₁ and \tilde{s}₂ at RN1 and RN2 can be estimated as:

$${\tilde{s}}_{1} = \frac{{{r}_{1}^{a} ( {h}_{11}^{a} )}^{*}}{\sqrt{{p}_{2}^{u}} {‖ {h}_{11}^{a} ‖}^{2}} = {s}_{1} + \frac{\sqrt{{p}_{2}^{u}} ( {h}_{11}^{a} ) * {h}_{21}^{a} {s}_{2} + {( {h}_{11}^{a} )}^{*} ( {I}_{1}^{a} + {n}_{1}^{a} )}{\sqrt{{p}_{1}^{u}} {‖ {h}_{11}^{a} ‖}^{2}}$$

$${\tilde{s}}_{2} = \frac{{{r}_{2}^{a} ( {h}_{22}^{a} )}^{*}}{\sqrt{{p}_{2}^{u}} {‖ {h}_{11}^{a} ‖}^{2}} = {s}_{2} + \frac{\sqrt{{p}_{1}^{u}} ( {h}_{22}^{a} ) * {h}_{12}^{a} {s}_{1} + {( {h}_{22}^{a} )}^{*} ( {I}_{2}^{a} + {n}_{2}^{a} )}{\sqrt{{p}_{2}^{u}} {‖ {h}_{22}^{a} ‖}^{2}}$$

where (h₁₁^{a})*, (h₂₂^{a})* are the complex conjugate of h₁₁^{a}, h₂₂^{a}. The power of the equivalent noise can be expressed as follows:

$${σ}_{1}^{2} = \frac{{p}_{2}^{u} {‖ {h}_{21}^{a} ‖}^{2} + {‖ {I}_{1}^{a} ‖}^{2} + {‖ {n}_{1}^{a} ‖}^{2}}{{p}_{1}^{u} {‖ {h}_{11}^{a} ‖}^{2}}$$

$${σ}_{2}^{2} = \frac{{p}_{1}^{u} {‖ {h}_{12}^{a} ‖}^{2} + {‖ {I}_{2}^{a} ‖}^{2} + {‖ {n}_{2}^{a} ‖}^{2}}{{p}_{2}^{u} {‖ {h}_{22}^{a} ‖}^{2}}$$

The corresponding Bit Error Rates (BER) probability of b₁ and b₂ at the access link are formulated as follows:

$${P}_{e}^{{a}_{1}} = \frac{1}{2} erfc ( \frac{1}{\sqrt{2} {σ}_{1}} )$$

$${P}_{e}^{{a}_{2}} = \frac{1}{2} erfc ( \frac{1}{\sqrt{2} {σ}_{2}} )$$

where er f c (x) is the complementary error function defined as:

$$erfc ( x ) = \frac{2}{\sqrt{π}} {\int }_{x}^{∞} {e}^{- {t}^{2}} d t$$

2) Backhaul Link Transmission

RN1 and RN2 forward/transmit signals s₁ and s₂, respectively, received from UN1 and UN2 to NCN based on the Alamouti scheme. If s₁ and s₂ are demodulated and decoded correctly at RN1 and RN2, RN1 and RN2 re-encode and re-modulate s₁ and s₂ then forward the signals to NCN at time slot t₂ and t₃ according to the scheme in Table I. The signals received at NCN are given by:

r₁^{b}=\sqrt{p₁^{r}}h₁₁^{b}s₁+\sqrt{p₂^{r}}h₂₁^{b}s₂+I₁^{b}+n₁^{b}

r₂^{b}=−\sqrt{p₁^{r}}h₁₁^{b}s₂*+\sqrt{p₂^{r}}h₂₁^{b}s₁*+I₂^{b}+n₂^{b}

where p₁^{r}, p₂^{r} are the power of signal transmission of RN1 and RN2, n₁^{b}, n₂^{b} are thermal noise, I₁^{b} and I₂^{b} are the interference from other RNs in the relay network. Let define \tilde{r}₁^{b} and \tilde{r}₂^{b} are as follows:

$${\tilde{r}}_{1}^{b} {=}^{Δ} \sqrt{{p}_{1}^{r}} {( {h}_{11}^{b} )}^{*} {r}_{1}^{b} + \sqrt{{p}_{2}^{r}} {{h}_{21}^{b} ( {r}_{2}^{b} )}^{*} = ( {p}_{1}^{r} {‖ {h}_{11}^{b} ‖}^{2} + {p}_{2}^{r} {‖ {h}_{21}^{b} ‖}^{2} ) {s}_{1} + \sqrt{{p}_{1}^{r}} {( {h}_{11}^{b} )}^{*} ( {I}_{1}^{b} + {n}_{1}^{b} ) + \sqrt{{p}_{2}^{r}} {h}_{21}^{b} ( {( {I}_{2}^{b} )}^{*} + {( {n}_{2}^{b} )}^{*} )$$

$${\tilde{r}}_{2}^{b} {=}^{Δ} \sqrt{{p}_{2}^{r}} {( {h}_{21}^{b} )}^{*} {r}_{1}^{b} + \sqrt{{p}_{1}^{r}} {{h}_{11}^{b} ( {r}_{2}^{b} )}^{*} = ( {p}_{1}^{r} {‖ {h}_{11}^{b} ‖}^{2} + {p}_{2}^{r} {‖ {h}_{21}^{b} ‖}^{2} ) {s}_{2} + \sqrt{{p}_{2}^{r}} {( {h}_{21}^{b} )}^{*} ( {I}_{1}^{b} + {n}_{1}^{b} ) + \sqrt{{p}_{1}^{r}} {h}_{11}^{b} ( {( {I}_{2}^{b} )}^{*} + {( {n}_{2}^{b} )}^{*} )$$

3) Direct and Backhaul Link Combination:

The NCN combines the signal received from UN1 and UN2 and signals forwarded by RN1 and RN2 by using Maximum Ratio Combing (MRC). \tilde{r}₁^{c} and \tilde{r}₂^{c} are defined and derived as:

$$\begin{matrix}\begin{matrix}{\tilde{r}}_{1}^{c} {=}^{Δ} {\tilde{r}}_{1}^{b} + \sqrt{{p}_{1}^{u}} {( {h}_{11}^{d} )}^{*} {r}^{d} \\ = ( {p}_{1}^{r} {‖ {h}_{11}^{b} ‖}^{2} + {p}_{2}^{r} {‖ {h}_{21}^{b} ‖}^{2} + {p}_{1}^{u} {‖ {h}_{11}^{d} ‖}^{2} ) {s}_{1} + \\ \sqrt{{p}_{1}^{r}} {( {h}_{11}^{b} )}^{*} ( {I}_{1}^{b} + {n}_{1}^{b} ) + \sqrt{{p}_{2}^{r}} {h}_{21}^{b} ( {( {I}_{2}^{b} )}^{*} + {( {n}_{2}^{b} )}^{*} ) + \\ \sqrt{{p}_{1}^{u} {p}_{2}^{u}} {( {h}_{11}^{d} )}^{*} {h}_{21}^{d} {s}_{2} + \sqrt{{p}_{1}^{u}} {( {h}_{11}^{d} )}^{*} ( {I}^{d} + {n}^{d} )\end{matrix} & \\ \begin{matrix}{\tilde{r}}_{2}^{c} {=}^{Δ} {\tilde{r}}_{2}^{b} + \sqrt{{p}_{2}^{u}} {( {h}_{21}^{d} )}^{*} {r}^{d} \\ = ( {p}_{1}^{r} {‖ {h}_{11}^{b} ‖}^{2} + {p}_{2}^{r} {‖ {h}_{21}^{b} ‖}^{2} + {p}_{2}^{u} {‖ {h}_{21}^{d} ‖}^{2} ) {s}_{2} + \\ \sqrt{{p}_{2}^{r}} {( {h}_{21}^{b} )}^{*} ( {I}_{1}^{b} + {n}_{1}^{b} ) - \sqrt{{p}_{1}^{r}} {h}_{11}^{b} ( {( {I}_{2}^{b} )}^{*} + {( {n}_{2}^{b} )}^{*} ) + \\ \sqrt{{p}_{1}^{u} {p}_{2}^{u}} {{h}_{11}^{d} ( {h}_{21}^{d} )}^{*} {s}_{1} + \sqrt{{p}_{2}^{u}} {( {h}_{21}^{d} )}^{*} ( {I}^{d} + {n}^{d} )\end{matrix} & \end{matrix}$$

Similar to section 1), the power of the equivalent noise can be expressed as follows:

$${σ}_{1}^{2} = \frac{\begin{matrix}{p}_{1}^{r} {‖ {h}_{11}^{b} ‖}^{2} ( {‖ {I}_{1}^{b} ‖}^{2} + {‖ {n}_{1}^{b} ‖}^{2} ) + {p}_{2}^{r} {‖ {h}_{21}^{b} ‖}^{2} ( {‖ {I}_{2}^{b} ‖}^{2} + {‖ {n}_{2}^{b} ‖}^{2} ) + \\ {p}_{1}^{u} {p}_{2}^{u} {‖ {h}_{11}^{d} ‖}^{2} {‖ {h}_{21}^{d} ‖}^{2} + {p}_{1}^{u} {‖ {h}_{11}^{d} ‖}^{2} ( {‖ {I}^{d} ‖}^{2} + {‖ {n}^{d} ‖}^{2} )\end{matrix}}{{( {p}_{1}^{r} {‖ {h}_{11}^{b} ‖}^{2} + {p}_{2}^{r} {‖ {h}_{21}^{b} ‖}^{2} + {p}_{1}^{u} {‖ {h}_{11}^{d} ‖}^{2} )}^{2}}$$

$${σ}_{2}^{2} = \frac{\begin{matrix}{p}_{2}^{r} {‖ {h}_{21}^{b} ‖}^{2} ( {‖ {I}_{1}^{b} ‖}^{2} + {‖ {n}_{1}^{b} ‖}^{2} ) + {p}_{1}^{r} {‖ {h}_{11}^{b} ‖}^{2} ( {‖ {I}_{2}^{b} ‖}^{2} + {‖ {n}_{2}^{b} ‖}^{2} ) + \\ {p}_{1}^{u} {p}_{2}^{u} {‖ {h}_{11}^{d} ‖}^{2} {‖ {h}_{21}^{d} ‖}^{2} + {p}_{2}^{u} {‖ {h}_{21}^{d} ‖}^{2} ( {‖ {I}^{d} ‖}^{2} + {‖ {n}^{d} ‖}^{2} )\end{matrix}}{{( {p}_{1}^{r} {‖ {h}_{11}^{b} ‖}^{2} + {p}_{2}^{r} {‖ {h}_{21}^{b} ‖}^{2} + {p}_{2}^{u} {‖ {h}_{21}^{d} ‖}^{2} )}^{2}}$$

The corresponding BER probabilities of b₁ and b₂ by combining at the NCN can be formulated as:

$${P}_{e}^{{c}_{1}} = \frac{1}{2} erfc ( \frac{1}{\sqrt{2} {σ}_{1}} )$$

$${P}_{e}^{{c}_{2}} = \frac{1}{2} erfc ( \frac{1}{\sqrt{2} {σ}_{2}} )$$

Thus the BER probabilities of b₁ and b₂ by cooperative relaying are given by:

Pₑ₁=1−(1−Pₑ^{a}^{₁})(1−Pₑ^{a}^{₂})(1−Pₑ^{c}^{₁})

Pₑ₂=1−(1−Pₑ^{a}^{₁})(1−Pₑ^{a}^{₂})(1−Pₑ^{c}^{₂})

The average BER of UN i can be formulated as:

P̅ₑᵢ=p_{f}(b₁)Pₑ₁+(1−p_{f}(b₁))Pₑ₂

where p_{f} (b₁) is the transmit probability of original bit b₁.

Assuming a real number σ̅ᵢ which meets the following equality:

$${\overline{P}}_{ei} = \frac{1}{2} erfc ( \frac{1}{\sqrt{2} {\overline{σ}}_{i}} ) .$$

Thus the capacity of UN i when sⱼ (j=1,2) is transmitted can be calculated by using the Shannon equation in the information theory as follows:

$${C}_{i} = {log}_{2} ( 1 + \frac{{‖ {s}_{j} ‖}^{2}}{{\overline{σ}}_{i}^{2}} ) .$$

Thus the capacity for UN i, i.e. Cᵢ, can be used in the utility function above for calculating the transmit powers according to the invention. Therefore, the transmit powers of the UNs and RNs can be updated with regular intervals.

### Relay Network Architecture

Moreover, the classic hexagon cellular network architecture is widely used in the art. In each hexagon cell of such network architecture a NCN (e.g. a base station) equipped with 3 directional antennas (the angle between two adjacent antennas is 120°) resides in the centre of the hexagonal macro cell.

The present relay networks in this disclosure are constructed by deploying RNs in the macro cellular network. Relay nodes are uniformly deployed around the donor NCN (e.g. BS) in the cell coverage so that more UNs (e.g. UEs) can benefit from the capacity improvement gain introduced by relaying. In conventional cellular networks, one of the largest obstacles is the signal attenuation. The signal quality deteriorates as the distance between two communication peers increases. The deployment of RNs in the network can shorten the communication distance between the BS and the UEs and therefore improve the capacity, especially for the UEs at the cell edges. Hence, the present relay networks provide improved coverage and capacity.

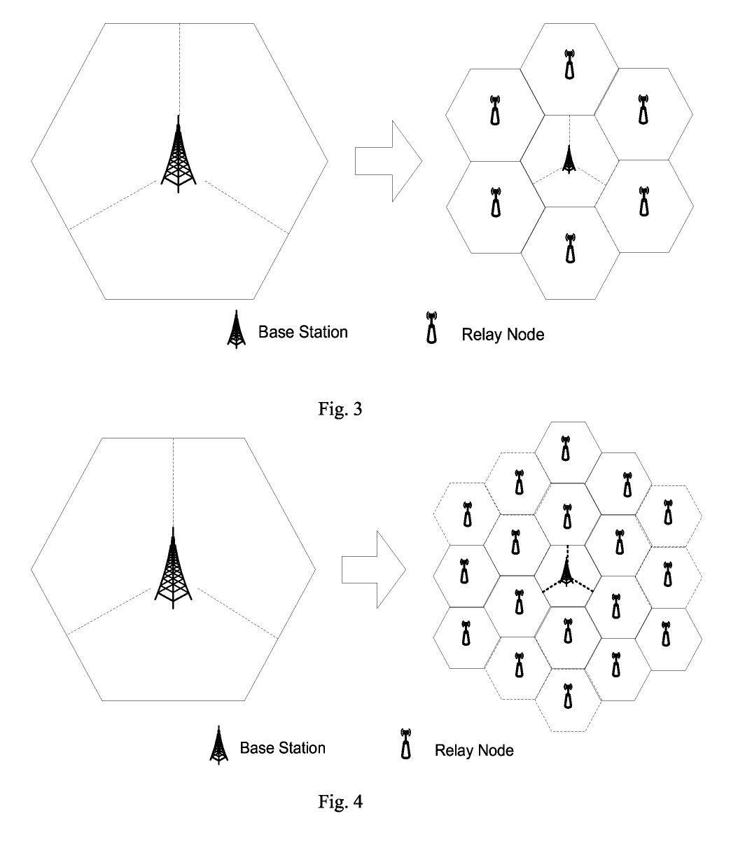

In a first relay network architecture according to an embodiment the introduced RNs are deployed at the edge of each macro cell, and each macro cell in the macro cellular network is divided into two areas, namely: a central area and an edge area as illustrated in FIG. 3. The central area is covered by the central NCN which plays the role of macro NCN (e.g. a BS) in the baseline model. The central area is further divided into three sectors by means of directional antennas of the central NCN as mentioned above. The edge area is located at the edge of each basic regular hexagonal cell where the edge area is divided into 6 small hexagonal cells with one RN located in each relay cell. The 6 RNs cooperate with the centrally located NCN by forwarding uplink signals to the UNs in the relay cells. The cooperation is coordinated by the NCN which is the donor NCN for its associated RNs.

In a second relay network architecture according to another embodiment the central area is covered by the NCN which plays the role of macro NCN (BS) in the baseline model. The central area is further divided into three sectors by means of directional antenna of the centrally located NCN. The edge area is located at the edge of each basic regular hexagonal cell where the edge area is divided into 12 small hexagonal cells with one RN located in each relay cell. The 12 small relay cells are split into two groups as indicated by same colour, and the dispersed six cells with same colour are controlled by the same central BS. The 6 small cells in the middle area are covered by 6 RNs. Each of the middle cells has one RN.

Furthermore, as understood by the person skilled in the art, any method according to the embodiments may also be implemented in a computer program, having code means, which when run by processing means causes the processing means to execute the steps of the method. The computer program is included in a computer readable medium of a computer program product. The computer readable medium may comprises of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

The present invention further relates to a communication device. Preferably, the present communication device is a network control node, and more preferably a base station device, such as e.g. an eNB in LTE systems.

It is realised by the skilled person that the communication device comprises the necessary communication capabilities in the form of e.g., functions, means, units, elements, etc. for executing the methods according to the invention which means that the devices can be modified, mutatis mutandis, according to any method of the present invention. Examples of such means, units, elements and functions are: receivers, transmitters, processors, encoders, decoders, mapping units, multipliers, interleavers, deinterleavers, modulators, demodulators, inputs, outputs, antennas, amplifiers, DSPs, etc which are suitable arranged together. Furthermore, the communication device further comprises a calculating unit arranged for simultaneously calculating the transmit powers for each user node and each relay node by maximising the present utility function f(pᵢ^{u}, pⱼ^{r}) . The calculating unit may be a software application of a processor or a hardware implementation.

Especially, the processors of the communication device may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present invention is not limited to the embodiments described above, but also relates to and incorporates all embodiments within the scope of the appended independent claims.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for determining multiple transmit powers in a cellular wireless communication system, the wireless communication system comprising a network control node, a number of neighbouring relay nodes j, where j=1,2, . . . , M, and a number of user nodes i, where i=1,2, . . . , N, the N user nodes being served by the M relay nodes, and the network control node cooperating with the M relay nodes j by acting as a donor network control node for the M relay nodes j, the method comprising:
simultaneously calculating transmit powers for each user node i and each relay node j by maximising a utility function f(pᵢ^{u}, pⱼ^{r}) expressing a ratio of a sum of channel capacities for the N user nodes i over a sum of transmit powers for the N user nodes i and the M relay nodes j, where pᵢ^{u} is the transmission power for user node i and pⱼ^{r} is the transmission power for relay node j .

2. The method according to claim 1, wherein the utility function f(pᵢ^{d}, pⱼ^{r}) has a channel capacity constraint such that the channel capacity for the N user nodes i should exceed a given minimum channel capacity threshold θ_{c}.

3. The method according to claim 2, wherein the channel capacity threshold θ_{c} is fixed.

4. The method according to claim 2, wherein the channel capacity threshold θ_{c} is variable.

5. The method according to claim 4, wherein the channel capacity threshold θ_{c} is dependent on one or more parameters relating to one of: distribution of user nodes i, and capacity threshold set by a network control node for direct communication between user nodes i and the network control node.

6. The method according to claim 2, wherein the utility function f(pᵢ^{u}, pⱼ^{r}) has transmission power constraints such that the transmission power for the N user nodes i and the M relay nodes j, respectively, should be within a preset transmission power interval given by minimum and maximum transmit powers according to the relation pₘᵢₙ^{u}≦pᵢ^{u}≦pₘₐₓ^{u}, pₘᵢₙ^{r}≦pⱼ^{r}≦pₘₐₓ^{r}, where pₘᵢₙ^{u}, pₘᵢₙ^{r}, pₘₐₓ^{u}, pₘₐₓ^{r} are the pre-set thresholds for the minimum and maximum transmission powers for user nodes i and relay nodes j, respectively.

7. The method according to claim 6, wherein the utility function f(pᵢ^{u}, pⱼ^{r}) is given by:
$$f ( {p}_{i}^{u} , {p}_{j}^{r} ) = \frac{{\sum }_{i = 1}^{N} {C}_{i}}{{\sum }_{i = 1}^{N} {p}_{i}^{u} + {\sum }_{j = 1}^{M} {p}_{j}^{r}} , \\ s . t . \\ {C}_{i} \geq {θ}_{C} ,$$
where Cᵢ denotes the channel capacity for user node i.

8. The method according to claim 1, wherein simultaneously calculating the transmit powers for the N user nodes i and the M relay nodes j is performed in the network control node.

9. The method according to claim 8, wherein the network control node is a base station node.

10. The method according to claim 8, wherein the calculated transmit powers pᵢ^{u}, pⱼ^{r} are signalled by the control node to the M relay nodes j and the N user nodes i, respectively.

11. The method according to claim 1, wherein the M relay nodes j operate in Decode-and-Forward (DF) mode.

12. The method according to claim 1, further comprising:
transmitting, by the N user nodes i and the M relay nodes j, communication signals in the uplink with the respective calculated transmit powers pᵢ^{u}, pⱼ^{r}.

13. The method according to claim 1, wherein the cellular wireless communication system comprises a first user node, a second user node, a first relay node, and a second relay node.

14. The method according to claim 13, further comprising:
transmitting at a first time slot t₁, by the first and second user nodes, a first s₁ and a second s₂ communication signal, respectively;
receiving, by the first and second relay nodes and the network control node, the first s₁ and second s₂ communication signals;
forwarding at a second time slot t₂, by the first and second relay nodes, the first s₁ and second s₂ communication signals to the network control node;
receiving, by the network control node, the first s₁ and second s₂ communication signals transmitted from the first and second relay nodes; and
calculating channel capacities Cᵢ for the first and second user nodes, respectively, based on the first s₁ and second s₂ communication signals received at the network control node.

15. The method according to claim 14, further comprising:
forwarding at a third time slot t₃, by the first relay node, a negative complex conjugate of the second s₂ communication signal −s₂* to the network control node; and
forwarding at the third time slot t₃, by the second relay node, the complex conjugate of the first s₁ communication signal s₁*, to the network control node.

16. The method according to claim 14, wherein respective channel capacities Cᵢ for the first and second user nodes are calculated using a Maximum Ratio Combining (MRC) algorithm.

17. The method according to claim 14, wherein calculating the respective channel capacities Cᵢ is performed by the network control node.

18. The method according to claim 14, wherein the respective channel capacities Cᵢ for the first and second user nodes are used in the utility function f(pᵢ^{u}, pⱼ^{r}) for calculating the transmit powers for the first and second user nodes and the first and second relay nodes.

19. The method according to claim 1, wherein the cells of said cellular wireless communication system has a donor network control node deployed in a centre of a macro cell and a plurality of relay nodes deployed at edges of the macro cell.

20. The method according to claim 19, wherein six relay nodes are symmetrically arranged around each donor network control node, each relay node covering a relay node cell.

21. The method according to claim 1, wherein the cellular wireless communication system is a 3GPP wireless communication system.

22. The method according to claim 21, wherein the user nodes are user equipment (UE).

23. A computer program product comprising a computer readable medium and a computer program, wherein the computer program is stored in the computer readable medium, the computer program product is comprised in a communication device for determining multiple transmit powers in a cellular wireless communication system, wherein the cellular wireless communication comprises: a network control node, M number of neighbouring relay nodes j, where j=1,2, . . . , M, and N number of user nodes i, where i=1,2, . . . , N; the N user nodes being served by the M relay nodes, and the network control node cooperating with the M relay nodes by acting as a donor network control node for the M relay nodes; wherein the computer program, when executed, causes the communication device to:
simultaneously calculate transmit powers for each user node i and each relay node j by maximising a utility function f(pᵢ^{u}, pⱼ^{r}) expressing a ratio of a sum of channel capacities for the N user nodes i over a sum of transmit powers for the N user nodes i and the M relay nodes j, where pᵢ^{u} is the transmission power for user node i and pⱼ^{r} is the transmission power for relay node j.

24. A communication device arranged for communication in a cellular wireless communication system which comprises: a network control node, M number of neighbouring relay nodes j, where j=1,2, . . . , M, and N number of user nodes i, where i=1,2, . . . , N; the N user nodes being served by the M relay nodes, and the network control node cooperating with the M relay nodes by acting as a donor network control node for the M relay nodes; the communication device comprising:
a processor arranged for simultaneously calculating transmit powers for each user node i and each relay node j by maximising a utility function f(pᵢ^{u}, pⱼ^{r}) expressing a ratio of a sum of channel capacities for the N user nodes i over a sum of transmit powers for the N user nodes i and the M relay nodes j, where pᵢ^{u} is the transmission power for user node i and pⱼ^{r} is the transmission power for relay node j.

25. The communication device according to claim 24, wherein the communication device is the network control node

26. The communication device according to claim 25, wherein the network control node is a base station.
